(19) United States
(12) Patent Application Publication
(10) Pub. No.: US 2011/0289779 A1
(43) Pub. Date: Dec. 1, 2011

(54) BLADE UNIT FOR A SAFETY RAZOR

(76) Inventors: Alexandr Volodin, Novokuznetsk (RU); Taras Volodin, Novokuznetsk (RU)

(21) Appl. No.: 13/001,333

(22) PCT Filed: Sep. 28, 2009
(86) PCT No.: PCT/RU2009/000497

§ 371 Date: Dec. 23, 2010

(30) Foreign Application Priority Data
Dec. 10, 2008 (RU) 2008150012

(51) Int. Cl. B26B 21/22

(52) U.S. Cl. 30/50

(57) ABSTRACT

A blade unit for a safety razor comprises a plurality of elongated blades (4) with a continuously curved cutting edge (8). The shape of the cutting edge (8) is defined according to the formula R_{u3z}=k·L; where: Rᵤₛᵣ is the bending radius of the blade; k is a coefficient of proportionality equal to 1÷5; and L is the chord length of a curve with a radius of Rᵤₛᵣ. The blades (4) have a third support point. This provides for easy and effective shaving.

### FIELD

The invention relates to safety razors having blade units with a plurality of blades having cutting edges.

### BACKGROUND

A known razor (see Russian Federation Patent No. 2336156, B26B 21/22, 2008) includes a blade unit and a body having a recess. The blade unit includes a plurality of elongated metal blades with cutting edges and first and second plastic units. Smooth cutting edges of these metal blades form a shaving surface. The metal blades have first and second longitudinal ends. The first and second longitudinal ends are attached respectively to the first and second plastic units to form a single unit. The metal blades are attached to each other at the ends. The blade unit is fixed in the mentioned recess razor.

A disadvantage of this design is that the metal blades with longitudinal ends have only two points of support at their ends and the smooth cutting edges of the metal blades cannot maintain the angle of the blades with respect to the surface being shaved.

A known razor, adopted as the prototype (see Russian Federation Patent No. 2331508, B26B 21/22, 2008) includes a blade unit and a body having a recess. The blade unit includes a plurality of smooth elongated metal blades with cutting edges. The cutting edges of these metal blades form a shaving surface. The metal blades have first and second longitudinal ends. The first longitudinal ends are connected to each other with first welded joints and the second longitudinal ends are connected to each other with second welded joints. The metal blades are fixed at the first and second longitudinal ends.

A disadvantage of the above design is that the smooth cutting edge of the blade allows coverage of only a small surface of the hair being cut, whereas this method of attaching the blades at two points of support leads to a significant change in the angle of the cutting edge with respect to the working surface, which is especially noticeable when using a blunt cutting edge—as a result the hair is not being cut but rather “ripped”.

### BRIEF DESCRIPTION OF DRAWINGS

Example embodiments are illustrated by way of example and not limitation in the figures of the accompanying drawings,

in which like references indicate similar elements and in which:

FIG. 1 shows blades mounted in the body of the cartridge.

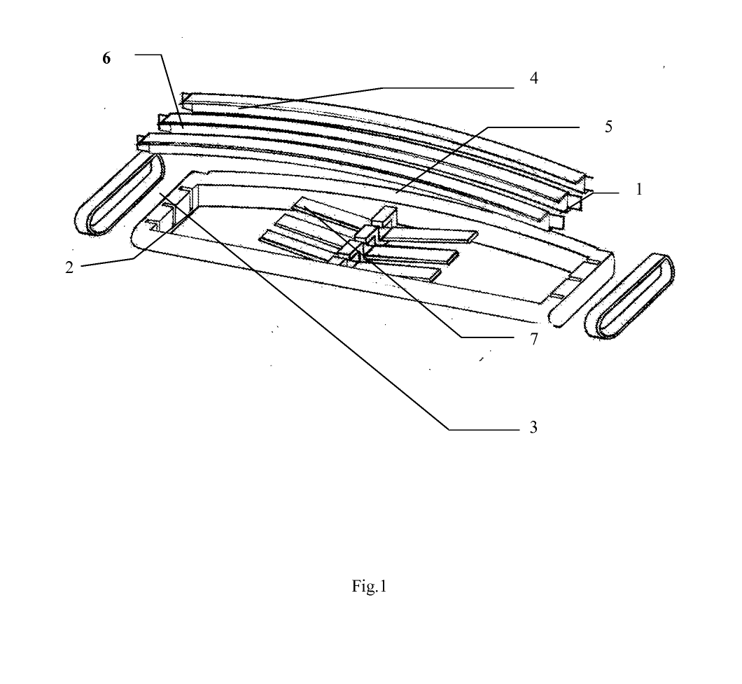

FIG. 2 shows a sectional view of a blade.

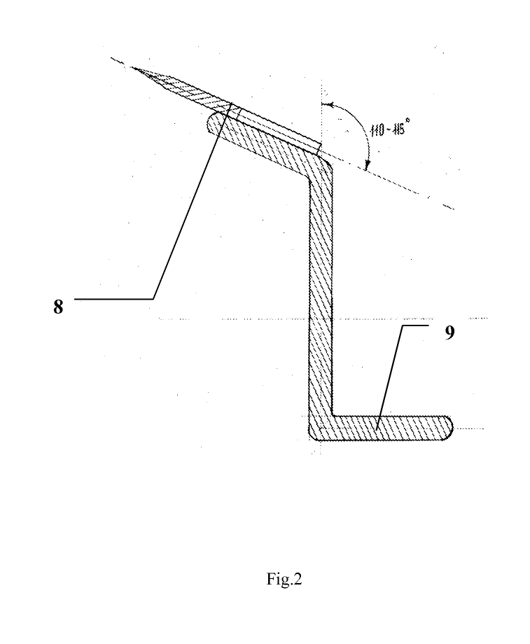

### DETAILED DESCRIPTION

The objective of the proposed device is to create a blade unit, which provides an easy and less irritable shave while providing greater coverage of the surface of the hair being cut by the cutting edge of the blade.

This technical result is achieved by having a blade unit comprising a plurality of elongated blades with sharp edges forming a shaving surface and having two points of attachment to the bearing elements, the blades having continuously curved cutting edge and continuously curved supporting element, and the blades having a third point of support in the central part with positioning springs, the shape of the cutting edge representing a part of the circle with a radius determined by the formula:

Rᵤₛᵣk·L,

wherein:
Rᵤₛᵣ—radius of the blade's curve;
k—proportionality coefficient equal to 1÷5.
L—length of the chord of the curve with a radius Rᵤₛᵣ.

A blade unit includes a plastic cartridge housing 1, positioning slots 2, retaining elements 3, continuously curved blades 4, blade holders 5, support plates 6, positioning springs 7. Mounting of the continuously curved blades 4 in the plastic cartridge housing 1 is performed by having the support plates 6 hold the continuously curved blades 4 in the positioning slots 2 of the two retaining elements 3 and by having the positioning springs 7 press the continuously curved blades 4 the to the blade holders 5. A cutting blade edge 8 is connected to a z-shaped base having an edge 9 for fixing with the holder 8.

The shape of the curve of the blade is taken as a part of the circle with the radius calculated by the formula:

Rᵤₛᵣ=k·L,

wherein:
Rᵤₛᵣ—radius of the blade's curve;
k—proportionality coefficient equal to 1÷5.
L—length of the chord of the curve with a radius Rᵤₛᵣ.

The continuously curved cutting edge allows reducing of the effort in cutting hair due to the small angular movement of the blade with respect to the hair being cut, thus increasing the contact of the blade surface with the body.

The installation angle of the continuously curved cutting edge with respect to the vertical axis is 110-115°. The value of this angle is due to the geometry of the cutting edge of the blade, whereas increasing the value of the angle will reduce the effectiveness of shaving.

Presence of the third point of support allows reallocating of the forces that arise when cutting the hair from the torsion force to tensile force, thereby allowing maintaining the angle of the blade with respect to the shaving surface and making shaving easier and less irritable.

1. A unit of a safety razor comprising a plurality of elongated blades with cutting edges forming a shaving surface and having two points of attachment to the bearing element, wherein the blades have continuously curved cutting edges and continuously curved supporting elements, the blades having a third point of support in their central part by positioning springs, the shape of the cutting edge being a part of a circle with a radius determined by the formula:
R_{u3z}=k·L,
wherein:
Rᵤₛᵣ—the radius of the blade's curve;
k—proportionality coefficient equal to 1÷5; and
L—length of the chord of the curve with a radius Rᵤₛᵣ.
